(19) United States
(12) Patent Application Publication
(10) Pub. No.: US 2004/0053767 A1
(43) Pub. Date: Mar. 18, 2004

(54) Electrophoretically redensified sio2 moulded body method for the production and use thereof

(76) Inventors: Fritz Schwertfeger, Muhldorf (DE); Johann Weiss, Sauerlach (DE); Rolf Clasen, Saarbrucken (DE); Jan Tabellion, Riegelsberg (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/362,986

(22) PCT Filed: Sep. 6, 2001
(86) PCT No.: PCT/EP01/10296

(30) Foreign Application Priority Data
Sep. 7, 2000 (DE) 10044163.7

(51) Int. Cl. C03C 3/06; B29C 67/24

(52) U.S. Cl. 501/54; 264/414; 264/628

(57) ABSTRACT

The invention relates to a method for producing porous SiO2 green bodies having an extremely high green density, or porous SiO2 green bodies having an internal density gradient which is adjusted in a targeted manner. The inventive method is characterised in that a porous SiO2 green body known per se and consisting of amorphous SiO2 is redensified by electrophoretically depositing SiO2 particles in the pores of the green body.

The invention relates to SiO₂ shaped bodies which have been densified further by electrophoresis, to processes for producing them and to their use.

Porous, amorphous SiO₂ shaped bodies are used in numerous technical fields. Examples which can be mentioned include filter materials, thermally insulating materials or heat shields.

Furthermore, all kinds of quartz goods can be produced from amorphous, porous SiO₂ shaped bodies by means of sintering and/or melting. High-purity porous SiO₂ shaped bodies can be used, for example, as preforms for glass fibers or optical fibers. Furthermore, it is also possible to use this route to produce crucibles for pulling silicon single crystals.

Irrespective of the use of the porous shaped bodies, it is always attempted to produce a shaped body which is as far as possible stable and near net shape. Both these criteria are most easily ensured if the porous body has the highest possible filling level. As a result, very little to no shrinkage occurs during the production of the shaped body.

If the porous SiO₂ shaped bodies are to be subjected to a subsequent heat treatment, e.g. sintering, in order to obtain nonporous SiO₂ shaped bodies, the highest possible density of the green bodies with the smallest possible pores and the tightest possible pore radius distribution is particularly desirable, since in this way it is possible to produce a nonporous shaped body which is as far as possible near net shape and dimension. Furthermore, it is in this way possible to reduce the sintering temperature required.

In order, during sintering, to ensure that the dimensional stability is as high as possible or to achieve only partial sintering of a shaped body, furthermore a density gradient which can be set deliberately within a porous shaped body is advantageous. As a result, some regions can be sintered at even a relatively low temperature (grain boundary fusion), while other regions still retain dimensional stability or are unsintered. Furthermore, the directional sintering front which results from a deliberately set density gradient within a porous shaped body can have advantageous effects on the heat-conducting properties of the shaped body. The result of this is that no pores and/or gas bubbles are included in the sintered material during the sintering process. As a result, it is possible, as it were, to carry out steady-state in-situ zone sintering.

DE 19943103 has disclosed dispersions and shaped bodies and their production which have a filling level of more than 80% by weight and contain amorphous SiO₂ particles with a bimodal grain size distribution. Although this process is suitable for producing very high filling levels, it cannot be used to achieve a targeted density gradient within a shaped body.

A wet-chemical process for shaping porous SiO₂ shaped bodies is the electrophoretic deposition of particles, as described for example in EP 200242. The term electrophoretic deposition is understood as meaning the movement and coagulation of electrically surface-charged particles in a suspension below an applied static electric field. The deposition of the particles takes place at one of the two electrodes. To avoid problems which are inherent to the process of depositing amorphous SiO₂ particles from aqueous suspensions, such as the formation of bubbles, the electrophoretic deposition can also be modified by using ion-permeable membranes, as described in EP 446999. The deposition and shaping of the green body then take place at the membrane, which is impermeable to colloidal particles. The solids contents of the green bodies which are achieved with these processes is up to 60% by weight.

Electrophoretic deposition has been in widespread use for many years for coating electrical components with polymer films. In the ceramic materials sector, there are only a few applications, which likewise relate primarily to the coating of electrically conductive surfaces.

U.S. Pat No. 6,066,364 has disclosed an electrophoretic deposition process by means of which dense and firmly adhering layers can be produced on a substrate surface. The pores at the substrate surface are closed up and additional layers are deposited on the dense boundary layer.

U.S. Pat. No. 6,012,304 has described electrophoretic deposition of SiO₂ powder from water to produce molds from silica glass. Particles with a particle diameter in the range from 2-5 μm are used in order to ensure a high porosity within the deposited shaped body. If the deposited layers are highly porous, the water in the pores means that there is always an electrical conductivity, so that the electric field does not collapse and overall it is possible to deposit thick layers.

It was an object of the present invention to provide a simple, fast and inexpensive process with which porous SiO₂ green bodies with an extremely high green density or porous SiO₂ green bodies with a deliberately set density gradient within the green body can be produced.

The object is achieved by a process which is characterized in that a porous green body which is known per se and is made from amorphous SiO₂ is densified further by means of electrophoretic deposition of SiO₂ particles in the pores of the green body.

In principle, any green body which is known from the prior art can be used at the porous green body made from amorphous SiO₂. It is preferable to use a green body which has been produced using the process described in DE 19943103.

For the electrophoretic deposition of the SiO₂ particles within the pores of a porous SiO₂ green body, the green body which is to be densified is moved between two electrodes. The space between anode and green body is filled with a dispersion which contains the SiO₂ particles which are to be deposited in the pores of the green body and a dispersant. In addition, the green body may already have been impregnated with this dispersion before it is introduced between the two electrodes.

It is preferable to use solid or grid-like electrodes which are made from an electrically conductive and chemically stable material which does not dissolve when an electric field is applied.

Electrically conductive plastics, graphite or precious metals are particularly preferred electrode materials. Platinum is very particularly preferred. Furthermore, however, the electrodes may also consist of alloys and/or be coated with the abovementioned materials. This prevents the densified green body from being contaminated by foreign ions.

In the dispersion, polar or nonpolar organic solvents, such as for example alcohols, ethers, esters, organic acids, saturated or unsaturated hydrocarbons or water or mixtures thereof are used as dispersant.

The dispersant is preferably an alcohol, such as methanol, ethanol, propanol, or acetone or water or a mixture thereof. It is particularly preferably acetone or water or mixtures thereof, and very particularly preferably water.

The dispersants are particularly preferably used in high-purity form, as can be obtained, for example, using processes which are known from the literature or as are commercially available.

When using water, it is preferable to use specially purified water which has a resistance of ≧18 MΩ·cm.

The SiO₂ particles to be dispersed used are preferably amorphous SiO₂ particles.

The specific density of the SiO₂ particles is preferably between 1.0 and 2.2 g/cm³. The particles particularly preferably have a specific density of between 1.8 and 2.2 g/cm³. The particles especially preferably have a specific density of between 2.0 and 2.2 g/cm³.

The amorphous SiO₂ particles, such as for example fused or fumed silica, preferably have a grain size which is at most equal to the mean pore size of the green bodies. Particles with a mean grain size of between 50 nm and 10 μm are preferred. Particles with a mean grain size which is at least a factor 10, preferably at least a factor 100, lower than the mean pore size of the green body are particularly preferred.

With a mean grain size of this type, it is possible to penetrate and close up pores of from 100 nm to 10 μm, as are typically formed in the wet-chemical production of green bodies from amorphous SiO₂ (as described in DE 19943103).

The amorphous Sio₂ particles preferably have a BET surface area of 0.001 m²/g-400 m²/g, particularly preferably 10 m²/g-380 m²/g, and very particularly preferably 50 m²/g-380 m²/g.

The amorphous SiO₂ particles preferably have a crystalline content of at most 1%. Furthermore, they preferably undergo the minimum possible interaction with the dispersant.

Amorphous highly disperse silicas (fumed silica produced via flame pyrolyis) preferably have these properties. They are commercially available, for example under the name of HDK (Wacker-Chemie), Cabo-Sil (Cabot Corp.) or Aerosil (Degussa).

If the above criteria are satisfied, it is also possible to use particles of other origin, such as for example natural quartz, quartz glass sand, vitreous silica, milled quartz glasses or milled quartz glass waste, resintered silica (fused silica) and any type of amorphous sintered or compacted SiO₂, as well as chemically produced silica glass, such as for example precipitated silica, xerogels or aerogels.

Of course, it is also possible for mixtures of different SiO₂ particles to be dispersed. In a particular embodiment of the process, the SiO₂ particles are in high-purity form, i.e. with a foreign atom content, in particular of metals, of ≦300 ppmw (parts per million per weight), preferably ≦100 ppmw, particularly preferably ≦10 ppmw and very particularly preferably ≦1 ppmw.

The SiO₂ particles are dispersed in the dispersant in a manner which is known per se. All methods which are known to the person skilled in the art can be used for this purpose. It is possible to set any desired filling levels. However, it is preferable to set filling levels of from 5 to 60% by weight of SiO₂ particles, particularly preferably filling levels of between 5 and 30% by weight of SiO₂ particles.

On account of the low filling levels, the SiO₂ particles can be dispersed more successfully and any thixotropy which occurs does not play a significant role.

The viscosity of the dispersion is preferably between 1 and 1000 mPa·s, particularly preferably between 1 and 100 mPa·s.

The process according to the invention can also be varied by using different dispersions in succession.

The dispersion may additionally contain metal particles, metal compounds or metal salts. These impart additional properties to the respective green bodies which are exposed to the process according to the invention. The metal particles, metal compounds or metal salts can be added during and/or after the production of the dispersion.

Mineral bases may also be added to the dispersant. Highly volatile substances, such as for example ammonium compounds, particularly preferably NH₃, tetramethylammonium hydroxide (TMAH) or NaOH, or mixtures thereof, are preferred.

A pH of preferably between 7 and 12, particularly preferably between 9 and 12, is set in the dispersant.

In the dispersant, it is preferable to set a zeta potential of between −10 and −70 mV, preferably between −30 and −70 mV. This stabilizes the particles within the dispersion, with the result that the dispersion is more liquid and can be processed more easily. Furthermore, the momentum acting on the particles during the electrophoretic deposition increases.

Alternatively, it is also possible to dispense with the addition of additives to water altogether, in order to minimize the level of impurities resulting from additives.

For the electrophoretic deposition, an electric DC voltages of from 5 to 100 V or an electric field strength of from 0.1 to 20 V/cm is applied between the electrodes. As a result, the dispersed SiO₂ particles are conveyed at different rates into the pores of the porous green body, where they are deposited.

The deposition time is generally between 5 seconds and 30 minutes, depending on the desired penetration depth and/or wall thickness and/or pore size of the green body.

The further densification of a green body by electrophoresis preferably takes place at a deposition rate of between 0.01-0.1 g/min·cm.

On account of the accumulation of SiO₂ particles in the pores of the green body, the process according to the invention leads to densification of the green body. The depth which is impregnated or densified further and the increase in the green density vary as a function of the process parameters, such as for example electric field, filling level of the dispersion, particle diameter, zeta potential and the like, and the properties of the green body, such as pore radius distribution and green density.

The process according to the invention can be used to impregnate both planar geometries and hollow bodies, preferably cylindrically symmetric geometries, in particular crucible-shaped green bodies, by electrophoresis.

In addition, to stabilize the deposition conditions, in particular the flow conditions, to support the geometries to be impregnated and to facilitate demolding, various films can be inserted between green body and electrode, in particular including films which are permeable to ions but not to colloidal SiO₂ particles.

Furthermore, at high deposition rates, in order to prevent electrophoretic deposition of a layer on the surface of the green body which is to be impregnated, the polarity of the applied electric field can briefly be reversed. The polarity of the applied electric field is preferably reversed briefly a number of times during the process. The polarity reversal preferably takes place for up to a third of the deposition time since the last polarity reversal. The brief polarity reversal allows a layer which has formed on the surface of the green body to be removed again, while at the same time the particles which have been deposited in the entries to the pores in the green body remain in the interior on account of capillary forces.

It is preferably possible for SiO₂ green bodies with pores with a mean diameter of between 50 nm and 10 μm to be completely or partially densified further. The impregnated depth in the SiO₂ green body produced according to the invention is between 1 μm and 10 mm, with a simultaneous rise in the green density in the densified regions of up to 30% compared to the undensified starting green body.

The present invention therefore also relates to porous SiO₂ shaped bodies with an extremely high green density. The term extremely high green density is to be understood as meaning shaped bodies having a green density of greater than 95%, preferably greater than 97%, particularly preferably greater than 99%.

The SiO₂ green bodies which can be produced by means of electrophoretic deposition are characterized in that in the region which has been densified further by electrophoresis they comprise at least 75% by volume, preferably at least 80% by volume, of SiO₂ particles. If the green body has a residual porosity, then there is a pore volume (determined by means of mercury porosimetry) of 1 ml/g to 0.01 ml/g, preferably 0.8 ml/g to 0.1 ml/g and particularly preferably have from 0.2 ml/g to 0.1 ml/g in the region which has been densified further by electrophoresis, and also have pores with a pore diameter of from 5 nm to 200 μm, preferably 5 nm to 50 nm.

The density in the region of the green body according to the invention which has been densified further by electrophoresis is preferably between 1.7 g/cm³ and 2.0 g/cm³.

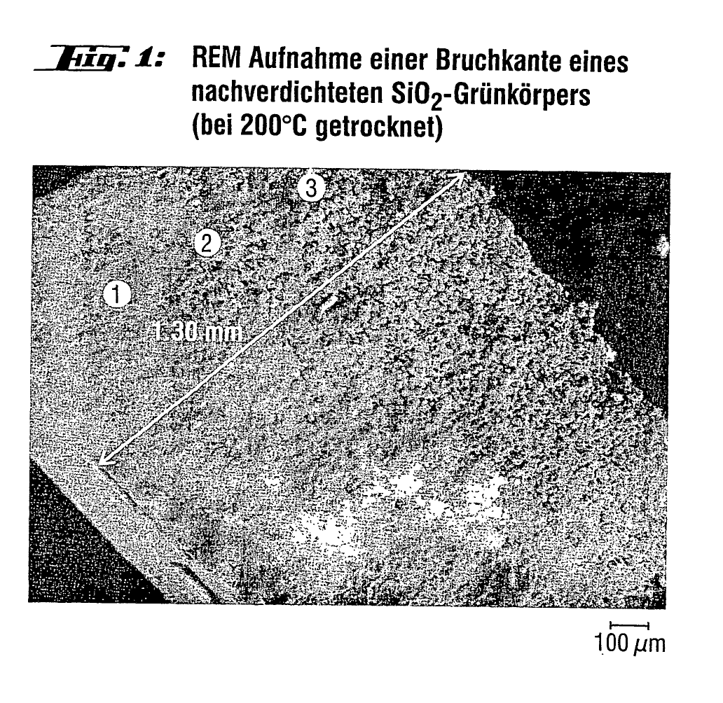

Overall, therefore, it is possible to produce both density gradients and pore gradients and pore volume gradients within an SiO₂ green body with the aid of the process according to the invention (cf. FIG. 1).

In one embodiment, a green body according to the invention with a given wall thickness has been densified further on one side of the wall while on the other side of the wall it has not been densified further at all or has only been densified further to a slight degree.

In a further embodiment, a green body according to the invention with a given wall thickness has been densified further on both sides of the wall and has undergone little to no further densification in the center only. A green body of this type has a sandwich structure in the wall. A green body of this type can be produced by carrying out the process according to the invention twice, the further densification by electrophoresis being carried out successively for both sides of the wall.

On account of its particular properties, there are numerous possible applications for a green body according to the invention, for example as filter materials, thermal insulation materials, heat shields, catalyst support materials and as a preform for glass fibers, optical fibers, optical glasses or all kinds of quartz goods.

In a further embodiment of the invention, the porous green bodies are completely or partially mixed with a very wide range of molecules, materials and substances. Molecules, materials and substances which are catalytically active are preferred. In this context, it is possible to use all methods which are known to the person skilled in the art, for example as described in U.S. Pat. No. 5,655,046.

The green bodies according to the invention can be subjected to sintering. In this case, all methods which are known to the person skilled in the art, such as for example vacuum sintering, zone sintering, arc sintering, plasma or laser sintering, inductive sintering or sintering in a gas atmosphere or gas stream can be used. Sintering in a vacuum or a gas stream is preferred. Sintering in a vacuum using pressures of between 10⁻⁵ mbar and 10⁻³ mbar is particularly preferred. Pore-free green bodies according to the invention advantageously do not undergo any shrinkage during sintering.

The temperatures required for the sintering are between 1300° C. and 1700° C., preferably between 1400° C. and 1600° C.

As is known in the prior art, the green body can be sintered as it stands freely, in a lying or suspended position and using any method which is known to the person skilled in the art. Furthermore, sintering in a mold which is able to withstand sintering is also possible. In this context, molds made from materials which do not lead to subsequent contamination of the sintered item are preferred. Molds made from graphite and/or silicon carbide and/or silicon nitride are particularly preferred. If the green bodies to be sintered are crucibles, sintering on a mandrel, for example consisting of graphite, is also possible, as described for example in DE 2218766.

Furthermore, as is known in the prior art, the green bodies can also be sintered in a special atmosphere, such as for example He, SiF₄, in order to achieve further purification and/or to enrich certain atoms and molecules in the sintered item. In this context, it is possible to use all methods which are known to the person skilled in the art, as described for example in U.S. Pat. No. 4,979,971. Furthermore, for further purification it is also possible to use methods as described for example in EP 199787.

Preferred substances for further purification in this context are those which form highly volatile compounds, such as for example metal halides, with the impurities. Preferred substances are reactive gases, such as for example Cl₂ or HCl, as well as readily decomposable substances, such as for example thionyl chloride. The use of thionyl chloride above the decomposition temperature is particularly preferred.

In this way, it is possible to produce a 100% amorphous (no cristobalite), transparent, gas-impermeable sintered silica glass shaped body with a density of at least 2.15 g/cm³, preferably 2.2 g/cm³.

The invention also relates to a process in which a green body which has been densified further in accordance with the invention are subjected to sintering, characterized in that the sintering temperature is selected in such a way that, on account of different particle size distributions and density differences, some regions of the green bodies have already been completely densely sintered while other regions still have a porosity.

This method provides a silica glass shaped body which has both open-pored and closed-pored densely sintered regions.

The subsequent densification of a region of the green body by means of smaller particles reduces the porosity in the impregnated region, i.e. the size of the pores decreases. Smaller and more densely packed particles sinter at lower temperatures and have a higher sintering activity. As a result, the sintering in the region which has been densified further begins at lower temperatures compared to other regions of the original green body.

Furthermore, this process prevents the inclusion of pores during the sintering. In accordance with a zone sintering as described for example in “Preparation of high-purity silica glasses by sintering of colloidal particles”, Glastech. Ber. 60 (1987) 125-132, the pores are expelled from the green body in the direction of advancing sintering, i.e. from the densified region to the undensified region, i.e. in-situ zone sintering takes place given an isotropic temperature distribution in the material being sintered.

All methods which are known to the person skilled in the art, such as for example vacuum sintering, zone sintering, arc sintering, plasma or laser sintering, inductive sintering or sintering in a gas atmosphere or gas stream can be used for the sintering. Sintering in a vacuum or a gas stream is preferred. Sintering in a vacuum at pressures of between 10⁻⁵ mbar and 10⁻³ mbar is particularly preferred.

The temperatures required for the sintering are between 1300° C. and 1600° C., preferably between 1300° C. and 1500° C. The sintering behavior is dependent on the depth of the region which has been densified further by electrophoresis, its density and the particle sizes introduced.

The green body can be sintered and if appropriate purified further as known in the prior art and as has already been described in the application.

In this way, it is possible to produce a 100% amorphous (no cristobalite), sintered silica glass shaped body having a density gradient.

In one embodiment, the 100% amorphous sintered silica glass shaped body has been partially densely sintered (transparent, gas-impermeable) and partially contains pores.

In another embodiment, the 100% amorphous sintered silica glass shaped body has a wall with a sandwich structure, i.e. the central region of the wall, as seen in cross section, has a high porosity, and the outer regions of the wall, as seen in cross section, have been densely sintered and do not have any porosity. A shaped body of this type can be obtained by sintering a green body which has been densified further on both sides.

In a particular embodiment, the sintered silica glass shaped body does not have any gas inclusions and has an OH group concentration of ≦1 ppm.

In a particular embodiment, in which high-purity materials are used in all steps, the sintered shaped body has a foreign atom content in particular of metals of ≦300 ppmw, preferably ≦100 ppmw, particularly preferably ≦10 ppmw and very particularly preferably ≦1 ppmw.

A silica glass shaped body which has been produced in this way is in principle suitable for all applications in which silica glass is used. Preferred application areas are all types of quartz goods, glass fibers, optical fibers and optical glasses.

High-purity silica glass crucibles for pulling silicon single crystals represent a particularly preferred application area.

A silica glass crucible of this type has a gas-impermeable glaze on the inner side and a porosity on the outer side, which results in limited infrared reflection in terms of the thermal conduction properties.

The pores on the outer side are preferably on average no larger than 30 μm, particularly preferably no larger than 10 μm.

In another embodiment, a silica glass crucible of this type has a gas-impermeable glaze on the inner side and a gas-impermeable glaze on the outer side.

The sintered silica glass bodies may have added molecules, materials and substances which impart additional properties to the shaped bodies in question.

By way of example, admixing silicon particles and/or aluminum oxide and/or titanium oxide as described in U.S. Pat. No. 4,033,780 and U.S. Pat. No. 4,047,966 alters the optical properties of the sintered shaped bodies by reducing the SiOH groups and the water content. Furthermore, the oxygen content in the sintered shaped body is reduced by the silicon particles.

Furthermore, the dimensional stability during sintering or under thermal load on the sintered shaped body can be increased or influenced.

The dispersion used in the process according to the invention and/or the porous green body may be completely or partially mixed with compounds which promote or effect cristobalite formation. In this context, it is possible to use all compounds which are known to the person skilled in the art to promote and/or effect cristobalite formation, as described for example in EP 0753605, U.S. Pat. No. 5,053,359 or GB 1428788. In this context, BaOH and/or aluminum compounds are preferred.

Furthermore, it is possible, as described in U.S. Pat. No. 4,018,615, to completely or partially bring about cristobalite formation if crystalline SiO₂ particles are added to the dispersion and/or the porous green body. The crystalline particles should have the particle sizes which have been described for the amorphous SiO₂ particles.

After sintering of a green body of this type, the result is shaped bodies which have a cristobalite layer on the inner and/or outer side or consist entirely of cristobalite. If the sintered shaped bodies are in particular crucibles for the crystal pulling of Si single crystals, they are particularly suitable for crystal pulling, since they are more thermally stable and cause less contamination to, for example, a silicon melt. As a result, a higher yield can be achieved during crystal pulling.

A reduction in the migration of impurities during the pulling of single crystals can also be achieved by the presence of aluminum or aluminum-containing substances in the pulling crucible, as described in DE 19710672. This can be achieved by adding suitable particles or dissolved substances to the dispersion and/or the porous green body.

The following examples and comparative examples are used to further explain the invention.

### EXAMPLE 1

a) Production of green bodies in accordance with DE 19943103

300 g of double-distilled H₂O were placed in a 600 ml plastic container. 1464.7 g of fused silica (Excelica® SE-30 produced by Tokoyama, mean particle size 30 μm) were dispersed, by means of a metering balance, in a few minutes using a commercially available dissolver at constant torque at subatmospheric pressure (0.1 bar). Accordingly, the dispersion produced in this way had a solids content of 83.0% by weight.

Part of the dispersion was poured into three open, rectangular molds made from PTFE (6 cm*6 cm*1 cm). After 4 hours, the shaped bodies were demolded by breaking open the mold.

Two green bodies were dried in a drying cabinet at 200° C. The dried green bodies had a density of 1.67 g/cm³.

The pore radius distribution of a green body was determined by means of mercury porosimetry. The green body had a monomodal pore radius distribution with a pronounced maximum between 2 and 5 μm and a mean pore radius of 2.68 μm.

The second dried green body was sintered under a high vacuum (10⁻⁵ mbar) by being heated for 15 minutes to 1550° C. at a heating rate of 5° C./min.

The sintered shaped body obtained in this way had a density of 2.06 g/cm³. On account of the residual porosity which was present, the shaped body was not transparent and was still gas-permeable.

b) Further densification by electrophoresis

Once again, 400 g of double-distilled H₂O were placed in a 600 ml plastic container. 22 g of fumed silica (Aerosil® OX 50 produced by Degussa, BET surface area 50 m²/g) were dispersed within 5 min with the aid of a commercially available dissolver at constant torque. The dispersion produced in this way accordingly had a solids content of 5% by weight. 0.11 g of tetramethylammonium hydroxide (TMAH) was added to the dispersion produced in order to set the zeta potential of the particles, corresponding to a tetramethylammonium hydroxide content of 0.5% by weight, based on the mass of the dispersed OX 50. The viscosity of the dispersion produced in this way was 10 mPa·s, the pH was 9.4 and the specific electrical conductivity was 96 μS/cm.

The dispersion produced in this way was introduced into the anode-side chamber of an electrophoresis cell. The cathode chamber was filled with double-distilled water, mixed with 0.5% by weight of TMAH. The moist green body which had previously been produced was clamped between the anode chamber and the cathode chamber. The distance between cathode and anode was in total 5 cm. Then, an electric DC voltage of 10 V was applied to the electrodes of the electrophoresis chamber for 3 minutes. After each minute of the deposition time had been completed, the polarity of the electric field was reversed for 20 seconds, in order for a layer which may have been deposited on the surface of the green body and thereby blocks the entries to the pores to be removed again. Therefore, the total duration of the densification process was 4 minutes.

After the electrophoretic densification, the green body was dried at 200° C. in a drying cabinet.

The green body produced in this way had a gradual density change from the impregnated surface to the opposite surface. This can be demonstrated using SEM images (cf. FIG. 1). The densified region extended over a depth of 5 mm.

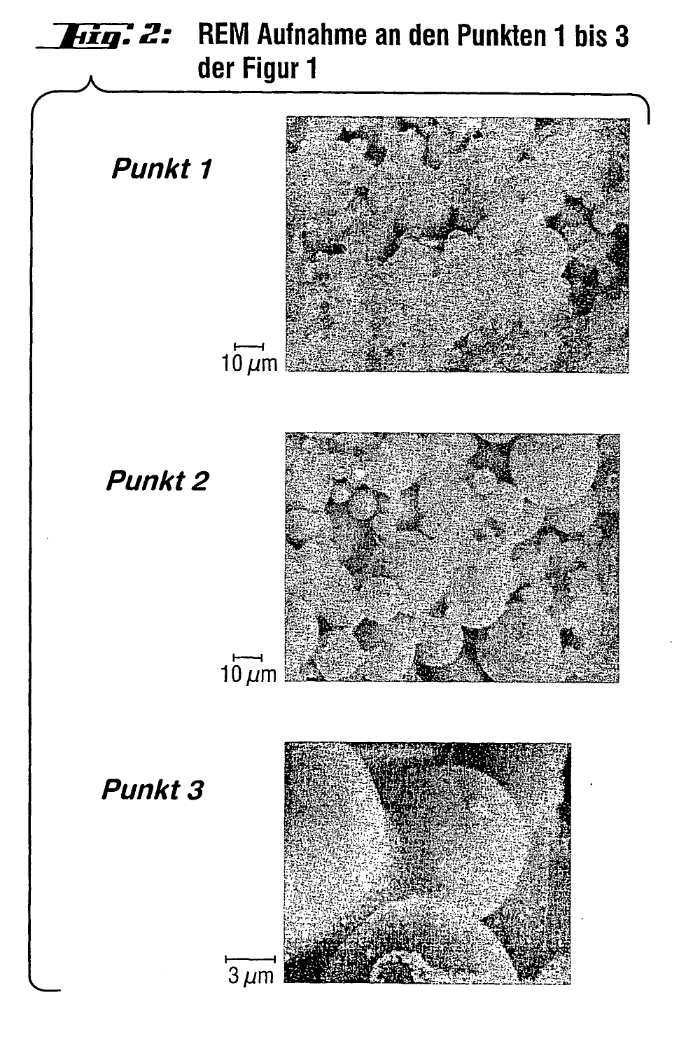

In the densified region, it was possible to determine a mean increase in the density from 1.67 g/cm³ to 1.78 g/cm³. The pore radius distribution of the electrophoretically densified green body was determined by means of mercury porosimetry. In addition to the pores of approx. 3 μm which were already present in the original green body, a bimodal pore distribution with a number of pores in the region of 40 nm was found. Accordingly, the proportion of pores in the micrometer range decreased compared to the unimpregnated green body. Using SEM images, it was possible to determine that in the impregnated region there were virtually only pores in the nanometer range, with an increase in pore radius as the distance from the impregnated surface increased (cf. FIG. 2).

The green body which had been produced and dried in this way was sintered under a high vacuum (10⁻⁵ mbar) by being heated for 15 minutes to 1550° C. at a heat-up rate of 5° C./min.

The shaped body produced in this way likewise had a density gradient. Starting from the densified surface, to a thickness of 5 mm, the shaped body consisted of 100% amorphous, transparent and gas-impermeable silica glass without gas inclusions, with a density of 2.20 g/cm³. The density decreased slightly toward the opposite surface (2.08 g/cm³). As a result, the sintered shaped body was not transparent at the opposite surface.

### EXAMPLE 2

a) Production of green bodies in accordance with DE 19943103

300 g of double-distilled H₂O were placed in a 600 ml plastic container. First of all, 87.9 g of fumed silica (Aerosil® OX 50 produced by Degussa, BET surface area 50 m²/g) and then 1376.8 g of fused silica (Excelica® SE-15 produced by Tokoyama, mean particle size 15 μm) were dispersed, by means of a metering balance, within 30 minutes using a commercially available dissolver at constant torque at subatmospheric pressure (0.1 bar). The dispersion produced in this way had a solids content of 83.0% by weight.

Part of the dispersion was poured into three open, rectangular molds made from PTFE (6 cm*6 cm*1 cm). After 4 hours, the shaped bodies were demolded by breaking open the mold and two were dried in a drying cabinet at 200° C.

The dried green bodies had a density of 1.67 g/cm³. The pore radius distribution of the dried green bodies was determined by means of mercury porosimetry. The green bodies had a bimodal pore radius distribution with a pronounced maximum between 2 and 5 μm and a second maximum between 90 and 120 nm.

b) Further densification by electrophoresis

Once again, 400 g of double-distilled H₂O were placed in a 600 ml plastic container. First of all, 22 g of fumed silica (Aerosil® OX 50 produced by Degussa, BET surface area 50 m²/g) and then 22 g of fumed silica (Aerosil® A380 produced by Degussa, BET surface area 380 m²/g) were dispersed within 10 min with the aid of a commercially available dissolver at constant torque. This corresponds to a solids content of 10% by weight. The viscosity of the dispersion produced in this way was 22 mPa·s, the pH was 3.9 and the specific electrical conductivity was 26 μS/cm.

The dispersion produced in this way was introduced into the anode-side chamber of the electrophoresis cell. The cathode chamber was filled with double-distilled water. The green body which had previously been produced and dried was clamped between the anode chamber and the cathode chamber. The procedure was then as described in Example 1.

The second green body, which had not been dried in the drying cabinet, was likewise clamped into the electrophoresis cell and impregnated electrophoretically using the process parameters described.

Then, the two green bodies which had been densified further by electrophoresis were dried at 200° C. in a drying cabinet.

The green bodies produced in this way both had a gradual density change from the impregnated surface to the opposite surface. It was impossible to determine any difference in the green density and pore radius distribution between the two green bodies. The densified region extended over a depth of in each case 5 mm.

In the densified region, it was possible to determine a mean increase in the density from 1.67 g/cm³ to 1.78 g/cm³. The pore radius distributions of the electrophoretically densified green bodies were determined by means of mercury porosimetry. In addition to the pores of approx. 3 μm which were already present in the original green body, a bimodal pore distribution with a pore content in the region of 40 nm was found. The proportion of pores in the micrometer range decreases accordingly compared to the undensified green body. Using SEM images, it was possible to determine that in the impregnated region there were virtually only pores in the nanometer range, the pore radius increasing at increasing distance from the impregnated surface.

The green bodies which had been produced and dried in this way were sintered under a high vacuum (10⁻⁵ mbar) by being heated for 15 minutes to 1550° C. with a heat-up rate of 5° C./min.

The shaped bodies produced in this way likewise had a density gradient. Starting from the densified surface, to a thickness of 5 mm, the shaped bodies consisted of 100% amorphous, transparent and gas-impermeable silica glass without glass inclusions, with a density of 2.20 g/cm³.

The density decreased slightly toward the opposite surface (2.06 g/cm³). As a result, the sintered shaped bodies were not transparent at the opposite surface.

1. A process for producing porous SiO₂ green bodies with an extremely high green density or porous SiO₂ green bodies with a deliberately set density gradient within the green body, characterized in that a porous SiO₂ green body which is known per se and is made from amorphous SiO₂ is densified further by means of electrophoretic deposition of SiO₂ particles in the pores of the green body.

2. The process as claimed in claim 1, characterized in that, for the electrophoretic deposition of the SiO₂ particles within the pores of the porous SiO₂ green body, the green body which is to be densified is moved between two electrodes and the space between anode and green body is filled with a dispersion which contains SiO₂ particles and a dispersant.

3. The process as claimed in claim 1 or 2, characterized in that electrodes which are made from an electrically conductive and chemically stable material and do not dissolve when an electric field is applied are used.

4. The process as claimed in one of claims 2 and 3, characterized in that polar or nonpolar organic solvents, organic acids, saturated or unsaturated hydrocarbons, water or mixtures thereof are used as dispersant.

5. The process as claimed in one of claims 1 to 4, characterized in that the SiO₂ particles used are amorphous SiO₂ particles.

6. The process as claimed in claim 5, characterized in that the amorphous SiO₂ particles have a BET surface area of 0.001 m²/g-400 m²/g.

7. The process as claimed in one of claims 2 to 6, characterized in that the dispersion has a filling level of 5 to 60% by weight of SiO₂ particles.

8. The process as claimed in one of claims 2 to 7, characterized in that the dispersion has a viscosity of between 1 and 1000 mPa·s.

9. The process as claimed in one of claims 2 to 8, characterized in that a pH of between 7 and 12 is set in the dispersant.

10. The process as claimed in one of claims 2 to 9, characterized in that a zeta potential of between −10 and −70 mV is set in the dispersant.

11. The process as claimed in one of claims 1 to 10, characterized in that an electric DC voltages of from 5 to 100 V or an electric field strength of from 0.1 to 20 V/cm is applied between the electrodes.

12. The process as claimed in one of claims 1 to 11, characterized in that a deposition time of between 5 seconds and 30 minutes is selected.

13. An SiO₂ green body with densified regions produced by means of the process as claimed in one of claims 1 to 12, characterized in that it has a green density which in the densified regions is up to 30% higher than in the undensified starting green body.

14. An SiO₂ green body having a green density of greater than 95%.

15. An SiO₂ green body, characterized in that it has a region which has been densified further by electrophoresis and in this region comprises at least 75% by volume of SiO₂ particles.

16. The SiO₂ green body as claimed in claim 15, characterized in that the density in the region which has been densified further by electrophoresis is between 1.7 g/cm³ and 2.0 g/cm³.

17. The SiO₂ green body as claimed in one of claims 13 to 16, characterized in that the depth in the SiO₂ green body which is impregnated by means of the process as claimed in one of claims 1 to 12 is between 1 μm and 10 mm.

18. A process for producing a silica glass shaped body, in which the SiO₂ green body as claimed in one of claims 13 to 17 is subjected to sintering, characterized in that the sintering temperature is selected in such a way that some regions of the green body have already been completely densely sintered while other regions still have a porosity.

19. A silica glass shaped body which has both open-pored and closed-pored densely sintered regions.

20. A 100% amorphous, sintered silica glass shaped body having a density gradient.

21. The sintered silica glass shaped body as claimed in claim 19 or 20, characterized in that it does not have any gas inclusions and has an OH group concentration of ≦1 ppm.

22. The use of the silica glass shaped body as claimed in one of claims 19 to 21 for pulling silicon single crystals.

23. A silica glass crucible for pulling silicon single crystals, comprising the silica glass shaped body as claimed in one of claims 19 to 21 with a gas-impermeable glaze on the inner side and a porosity on the outer side.

24. The silica glass crucible as claimed in claim 23, characterized in that the pores on the outer side are on average no larger than 30 μm.
